(19) United States
(12) Patent Application Publication
(10) Pub. No.: US 2011/0086965 A1
(43) Pub. Date: Apr. 14, 2011

(54) BORON NITRIDE NANOSHEET, METHOD FOR PRODUCING BORON NITRIDE NANOSHEET THEREOF AND COMPOSITION CONTAINING BORON NITRIDE NANOSHEET THEREOF

(75) Inventors: Chunyi ZHI, IBARAKI (JP); Yoshio BANDO, IBARAKI (JP); Chengchun TANG, IBARAKI (JP); Dmitri GOLBERG, IBARAKI (JP); Hiroaki KUWAHARA, YAMAGUCHI (JP)

(73) Assignees: NATIONAL INSTITUTE FOR MATERIALS SCIENCE, IBARAKI (JP); TEIJIN LIMITED, OSAKA (JP)

(21) Appl. No.: 12/758,787

(22) Filed: Apr. 12, 2010

(30) Foreign Application Priority Data
Oct. 8, 2009 (JP) 2009-234651

(51) Int. Cl. C08K 3/38; C01B 21/064

(52) U.S. Cl. 524/404; 423/290; 428/220

(57) ABSTRACT

A boron nitride nanosheet containing three-layered hexagonal boron nitride, which is in a form of multi-layered hexagonal boron nitride with some its layers peeled, can be produced by dispersing pristine hexagonal boron nitride powder in an organic solvent and by subjecting the fluid dispersion to ultrasonication.

This application claims the benefit of the Japanese Patent Application No. 2009-234651, filed on Oct. 8, 2009 in Japan.

### BACKGROUND OF THE INVENTION

### Field of the Invention

The present invention relates to a boron nitride nanosheet, a method for producing the boron nitride nanosheet, and a composition containing the boron nitride nanosheet.

Boron nitride is in two structures, namely in hexagonal and cubic structures, which are similar to those of graphite and diamond respectively. Hexagonal boron nitride has a laminar structure in which boron and nitrogen atoms are positioned alternately at the apex of a regular hexagon. Hexagonal boron nitride, a white substance having high conductivity and insulating properties, is used as a solid lubricant in vigorous environments, ultraviolet-light emitter, insulating and/or highly thermal conductive filler, and so on. In addition, a boron nitride nanotube having the same hollow structure as graphite is known.

As graphite having the same hexagonal structure as hexagonal boron nitride, two-dimensional (hereafter use “2D”) multi-layered lamellar crystal and a single-layer sheet are known. The graphite in the single-layer sheet structure is called graphene. Since its electron mobility is 10 to 100 times as high as that of silicon, its use is expected to achieve significantly higher IC operations for PCs, which is why methods for producing single-layer graphene from graphite have been studied vigorously. In an early stage, each layer was exfoliated using adhesive tape to produce graphene. However, since this method is unpractical, another method, in which a silicon carbide substrate is heated to detach the silicon on the surface first and then graphene is obtained from the residual carbon atoms, is being studied (K. S. Novoselov et al, Proc. Natl. Acad. Sci. Vol 102, P. 10451, 2005).

Since graphene is in the form of a single thin layer, it has the largest specific surface area of all the graphite structures. It has therefore an advantage that when used as a polymeric composite filler, addition of only a small amount graphene brings about significant improvement of electrical, mechanical, and thermal properties. For example, it was reported that the addition of graphene to polystylene only by 0.5 vol % achieved electrical conductivity 10¹⁴ times higher (S. Stankovich et al, Nature, Vol. 442, P. 282, 2006). Another report disclosed that addition of graphene to polymethyl methacrylate by 1 wt % improved elastic modulus, glass transition temperature, tensile strength, and decomposition temperature (T. Ramanathan et al, Nature Nanotechnol. Vol. 3, P. 327, 2008).

Similar to the hexagonal carbon nanostructure, the hexagonal boron nitride nanostructure is expected to be applicable as various functional materials. Namely, various structures, such as nanowires, nanotubes, and nanosheets, derived from the hexagonal boron nitride nanostructure, are expected to achieve higher functions and create new materials capable of providing new functions, capitalizing on their unique physical properties. For example, US-2009-0221734-A1 and WO2008/146400 disclose resin composition comprising boron nitride nanotubes. Moreover, JP2005-336009A discloses a structure in which a boron nitride nanosheet is formed on a boron nitride nanowire.

As a boron nitride nanosheet, 2D lamellar crystal is known, as in the case of graphite. However, with regard to thinner boron nitride sheet having fewer layers, a 2D boron nitride nanosheet having approximately 6 layers only has been reported, and the method used to obtain the nanosheet was the same as the one used to obtain graphene in the early stage, namely exfoliating each layer using adhesive tape (D. Pacile et al, Appl. Phys. Lett. Vol. 92, P. 133107, 2008)

### SUMMARY OF THE INVENTION

As described above, a thinner hexagonal boron nitride nanosheet having fewer layers is also sought after as in the case of graphite. However, the only proven method for producing such a nanosheet is to exfoliate a plurality of 2D boron nitride nanosheet layers using adhesive tape. This method of exfoliating two or more layers constituting a hexagonal boron nitride nanosheet is far from practical, and a structure having layers fewer than 6 has not been obtained yet.

In view of the situation described above, the present invention intends to provide a laminar hexagonal born nitride nanosheet wherein a plurality of layers has been peeled, namely a superthin-layer boron nitride sheet having fewer layers. The present invention also intends to provide a method for producing the boron nitride nanosheets (sometimes abbreviated as BNNSs hereinbelow) and a polymeric composition containing the boron nitride nanosheet. Furthermore, another purpose of the present invention is to provide a material containing the boron nitride nanosheet and thus having excellent optical properties.

The boron nitride nanosheet of the present invention has a structure in which a plurality of hexagonal boron nitride layers has been peeled. Specifically it contains three-layered hexagonal boron nitride. The hexagonal boron nitride nanosheet containing three-layered hexagonal boron nitride (hereafter referred to as “boron nitride nanosheet of the present invention) can be produced by dispersing hexagonal boron nitride powder in an organic solvent, and subjecting the fluid dispersion to ultrasonication.

Compared with bulk hexagonal boron nitride or known six-layered boron nitride nanosheet, the boron nitride nanosheet of the present invention has significantly larger specific surface area, and if used as polymeric composite filler, addition of even a small amount could improve polymeric properties of the composite. By increasing the amount of the boron nitride nanosheet of the present invention to be added to the polymeric composite, properties of the composite could be improved significantly. More specifically, the polymeric composition comprising the boron nitride nanosheet of the present invention and a polymeric resin material has excellent insulating properties and/or high thermal conductivity, and can therefore be used for microelectronics parts and/or optical device materials for photoluminescence and electroluminescence, and so on. In addition, the production method of the present invention ensures inexpensive and simple bulk production of boron nitride nanosheet of present invention.

### BRIEF DESCRIPTION OF THE DRAWINGS

FIGS. 1 (A) and (B) show scanning electron microscopic images of bulk powder boron nitride used as a raw material.

FIGS. 2 (A) and (B) show scanning electron microscopic images of the boron nitride nanosheet of the present invention.

FIG. 3 shows a transmission electron microscopic image of the edge portion of the boron nitride nanosheet of the present invention.

FIG. 4 shows another transmission electron microscopic image showing the edge portion of the boron nitride nanosheet of the present invention.

FIG. 5 is yet another transmission electron microscopic image showing the edge portion of the boron nitride nanosheet of the present invention.

FIG. 6 is statistics thickness distribution of the boron nitride nanosheets of the present invention.

FIG. 7 is a chart illustrating the light transmission of a polymethyl methacrylate composite film containing the boron nitride nanosheet of the present invention and a blank polymethyl methacrylate film.

FIG. 8 is a chart illustrating the measurement result of the coefficient of thermal expansion of the polymethyl methacrylate composite film containing the boron nitride nanosheet of the present invention and a blank polymethyl methacrylate film.

FIG. 9 is a chart illustrating the elastic modulus of the polymethyl methacrylate composite film containing the boron nitride nanosheet of the present invention and a blank polymethyl methacrylate film.

FIG. 10 is a chart illustrating the tensile strength of the polymethyl methacrylate composite film containing the boron nitride nanosheet of the present invention and a blank polymethyl methacrylate film.

### DETAILED DESCRIPTION OF THE PREFERRED EMBODIMENTS

The preferred embodiments of the present invention will hereinafter be described in detail by referring to the drawings.

The boron nitride nanosheet of the present invention is a few layered nanosheet created from multi-layered hexagonal boron nitride by peeling or exfoliating some of its layers. Specifically, it is an ultrathin three-layered sheet, or an ultrathin sheet containing three-layered hexagonal boron nitride produced from multilayered hexagonal boron nitride by peeling or exfoliating some of its layers. The thickness of the boron nitride nanosheet of the present invention preferably is from 1 nm to 15 nm, more preferably from 1 nm to 10 nm.

The boron nitride nanosheet of the present invention can be produced by subjecting the fluid dispersion created by dispersing hexagonal boron nitride powder in an organic solvent to ultrasonication. Raw materials used for producing the boron nitride nanosheet are hexagonal boron nitride powder and an organic solvent in which the powder is to be dispersed. Commercially available hexagonal boron nitride powder can be used. Organic solvents with a strong affinity for boron nitride are preferable. For example, one or more selected from a group containing aromatic hydrocarbons such as benzene, toluene, xylenes, chlorinated hydrocarbons such as chloroform, dichloromethane, carboxylic acid esters such as methyl acetate, ethyl acetate, propyl acetates, butyl acetates, aprotic polar solvents such as N,N-dimethylformamide, N,N-dimethylacetamide, N-methyl-2-pyrolidone, dimethyl sulfoxide, sulfolane, 1,3-dimethyl-2-imidazolidinone, tetramethylurea, and so on can be used.

After dispersing hexagonal boron nitride powder into a solvent having a strong affinity for boron nitride, ultrasonication is performed. Frequency of the ultrasonication is preferable within the range from 15 kHz to 400 kHz, more preferably within the range from 17 kHz to 100 kHz, most preferably 18 to 50 kHz. Output power of the ultrasonication is preferable within the range from 30 W to 1200 W, more preferably within the range from 100 W to 900 W, most preferably within the range from 200 W to 600 W. The ultrasonication is performed for at least 5 hours but no more than 24 hours. If the duration of ultrasonication is less than 5 hours, the yield of boron nitride nanosheet having thickness of 10 nm or less will become extremely low. Meanwhile, if the duration exceeds 24 hours, the hexagonal sheet structure will be broken, resulting in reduced size, which is not desirable. Preferably, the duration should be at least 8 hours but no more than 24 hours, more preferably from 10 hours to 24 hours.

It is desirable that centrifugal separation be performed after the ultrasonication to remove large particles remaining in the fluid dispersion. It is preferable that the rotation speed of the centrifugal separation from 3000 to 8000 rpm range. If the rotation speed is less than 3000 rpm, large particles will remain in the fluid dispersion, whereas if the rotation speed exceeds 8000 rpm, the yield of boron nitride nanosheets having thickness of 10 nm or less will become extremely low, which is not desirable.

The fluid dispersion that large particles were removed by centrifugal separation is then subjected to filtration to obtain solid, which is then dried to create a boron nitride nanosheet.

The boron nitride nanosheet thus produced has a thickness ranging from 1 nm to 15 nm, more preferably from 1 nm to 10 nm. More specifically, the area having the thickness of 10 nm or less accounts for 80% or higher of the entire boron nitride nanosheet obtained.

The boron nitride nanosheet of the present invention has significantly large specific surface area compared with bulk hexagonal boron nitride or known six-layered boron nitride nanosheet. Consequently, if it is used as filler for polymeric composite, even a small amount can improve the properties of polymer formation.

The polymeric composite of the present invention comprises at least one type of polymer and the BNNSs, wherein the BNNSs is present in an amount of 0.01 to 50 parts by weight, preferably 0.05 to 10 parts by weight, more preferably 0.1 to 5 parts by weight per 100 parts by weight of the polymer. In this patent application, the ratio of the BNNSs in the polymeric composite is also expressed by wt %, and, for example, “0.3 wt % of the boron nitride nanosheets were added (to polymer)” means 0.3 parts by weight of BNNSs was added to 100 parts by weight of polymer.

The polymer used for the polymeric composite of this invention is preferably at least one organic polymer selected from the group consisting of thermoplastic resin, thermosetting resin, rubber, and thermoplastic elastomer.

Thermoplastic resin includes polyethylene, polypropylene, ethylene-propylene copolymer, polymethylpentene, polyvinyl chloride, polyvinylidene chloride, polyvinyl acetate, ethylene-vinyl acetate copolymer, polyvinyl alcohol, polyvinyl acetal, fluoropolymers such as polyvinylidene fluoride and polytetrafluoroethylene, polyethylene terephthalate, polybutylene terephthalate, polyethylene naphthalate, polystyrene, polyacrylonitrile, styrene-acrylonitrile copolymer, ABS resin, polyphenylene ether (PPE) resin and modified PPE resin, aliphatic and aromatic polyamide, polyimide, polyamide imide, acrylic polymer, polycarbonate, polyphenylene sulfide, polysulfone, polyether sulfone, polyether nitrile, polyether ketone, polyketone, liquid crystal polymer, silicone resin, and ionomer.

The thermosetting resin includes epoxy resin, phenol resin, acrylic resin, urethane resin, polyimide resin, unsaturated polyester resin, diallyl phthalate resin, dicycropentadiene resin, and benzocyclobutene diene. The methods of hardening the thermosetting resin are not limited to thermosetting but include ordinary hardening methods, such as light setting and moisture setting.

The rubber may be natural rubber or synthetic rubber. Synthetic rubbers may include butadiene rubber, isoprene rubber, styrene-butadiene copolymer rubber, nitrile rubber, hydrogenated nitrile rubber, chloroprene rubber, ethylene-propylene rubber, chlorinated polyethylene, chlorosulfonated polyethylene, butyl rubber and butyl rubber halide, fluorine rubber, urethane rubber, and silicone rubber.

The thermoplastic elastomer includes styrene-butadiene or styrene-isoprene block copolymers and hydrogenated polymer thereof, styrene thermoplastic elastomer, olefin thermoplastic elastomer, vinyl chloride thermoplastic elastomer, polyester thermoplastic elastomer, polyurethane thermoplastic elastomer, and polyamide thermoplastic elastomer.

More preferable polymers for the polymeric composite of this invention is an acrylic polymer which is polymer of at least one monomer selected from the group of monofunctional acrylates and monofunctional methacrylates such as lower alkyl acrylates and lower alkyl methacrylates the alkyl groups of which have 1-8 carbon atoms, such as methyl acrylate, methyl methacrylate, ethyl acrylate and ethyl methacrylate, lower alkyl acrylates and lower alkyl methacrylates which have an alkyl group through an ethylene oxide group, such as ethoxyethyl acrylate and ethoxyethyl methacrylate, and modified alkyl acrylates and modified alkyl methacrylates in which the alkyl group is substituted by a glycidyl group or the like, such as glycidyl acrylate and glycidyl methacrylate; polyfunctional acrylates and polyfunctional methacrylates such as ethylene glycol diacrylate, ethylene glycol dimethacrylate, diethylene glycol diacrylate, diethylene glycol dimethacrylate, polyethylene glycol diacrylate, polyethylene glycol dimethacrylate, 1,4-butanediol diacrylate, 1,4-butanediol dimethacrylate, 2,2-bis[4-acryloxyethoxyphenyl]propane, 2,2-bis[4-methacryloxyethoxyphenyl]propane, trimethylol-propane triacrylate, trimethylolpropane trimethacrylate, pentaerythritol triacrylate, pentaerythritol trimethacrylate, pentaerythritol tetraacrylate and pentaerythritol tetramethacrylate.

The most preferable polymer for the polymeric composite of this invention is polymethyl methacrylate (sometimes abbreviated as PMMA herein below).

The polymeric composite of the present invention can be produced by mixing the BNNSs and at least one type of polymer.

As a method of the mixing, there is an employed method in which the polymer and BNNSs are melt-kneaded, for example. The melt-kneading method is not specially limited, while the kneading can be carried out with a single-screw or twin-screw extruder, a kneader, a Labo Plastomill, a Banbury mixer, a mixing roll, or the like.

When the method of the mixing the BNNSs and polymer uses a solvent, there can be employed a method in which the BNNSs are dispersed in a solvent to prepare a dispersion and the polymer is added and dissolved therein (method (A)), a method in which the polymer is dissolved in a solvent to prepare a polymer solution and the BNNSs are added and dispersed therein (method (B)), a method in which the polymer and the BNNSs are added to a solvent to prepare a polymeric composite (method (C), and the like.

In this invention, these methods can be employed singly or in combination. Of these, the method (A) in which the polymer is added and dissolved in the dispersion of the BNNSs is preferred.

That is, according to this invention, there is provided a method for producing the polymeric composite, comprising steps of:

(i) mixing the boron nitride nanotsheets with a solvent to obtain a dispersion,
(ii) adding the polymer to the dispersion to obtain a polymeric composite solution such that the amount of the boron nitride nanosheets is 0.01 to 50 parts by weight per 100 parts by weight of the polymer, and
(iii) removing the solvent from the polymeric composite solution.

Any solvents having affinity for boron nitride and capable of dissolving polymers are selectable for use depending on the polymer to be used for producing the polymeric composite. Among of organic solvents, preferred is one or more selected from aforementioned solvents about producing the boron nitride nanosheets by dispersion, for example, if polymethyl methacrylate is selected as a polymer, chloroform or N,N-dimethylformamide, and so on can be used.

It is suitable for optical material that the polymeric composite of the present invention involving transparent synthetic resins, such as polymethyl methacrylate, polystyrene, polypropylene, polyester, and polycarbonate, can be used as a polymer. The optical material containing the polymeric composite can be used for microelectronics parts and/or optical device materials for photoluminescence and electroluminescence.

The polymer composite of this invention can be formed into an article. The formed article includes a film and a fiber. Wet-forming and melt-forming can be applied to the forming.

That is, the formed article can be produced by wet-forming the polymeric composite solution into an article. The wet-forming can be carried out by casting the polymeric composite solution in a support, forming it to a predetermined thickness and removing the solvent. For example, when it is a film, the polymeric composite solution is cast on a substrate such as a glass or metal substrate to perform the forming and removing the solvent, whereby the film can be produced.

The formed article can be produced by melt-molding the polymeric composite of this invention. The melt-molding includes extrusion molding, injection molding and inflation molding. During the molding, flow orientation, shear orientation or stretch orientation can be carried out to improve the orientation of the polymer and the BNNSs, whereby the formed article can also be improved in mechanical properties.

Among of the formed articles mentioned above, the film is preferred, because the obtained film has improved thermal resistance and breakdown strength, and its optical transparency has been changed. The amount of boron nitride nanosheet of the present invention to be added to the polymer is approximately from 0.01 to 50 parts by weight per 100 parts by weight of the polymer. If the amount is less than 0.01 parts by weight, sufficient effect cannot be obtained, whereas if the amount exceeds 50 parts by weight, uniform formation cannot be achieved.

### EXAMPLES

### Example 1

1 g of boron nitride powder (special class reagent) by Wako Pure Chemical Industries Ltd. was added to 40 mL of N,N-dimethylformamide by Sigma-Aldrich Co. and dispersed in a 9.5 cm deep and 2.5 cm diameter Teflon™ container. The fluid dispersion was subjected to ultrasonication for 10 hours under the condition of the frequency of 19.5 kHz and output of 300 W using an ultrasonic processor. The fluid dispersion that underwent the ultrasonication was then subjected to centrifugal separation at the rotation speed of 5000 rpm. It was then filtered using a Teflon^{TR} filter and dried at 80° C. for 2 hours to obtain 1 mg of boron nitride nanosheet.

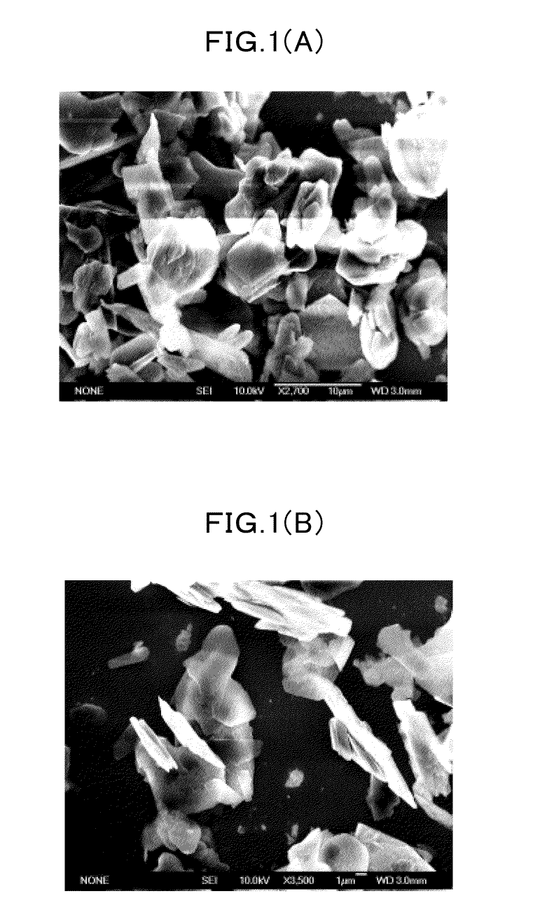

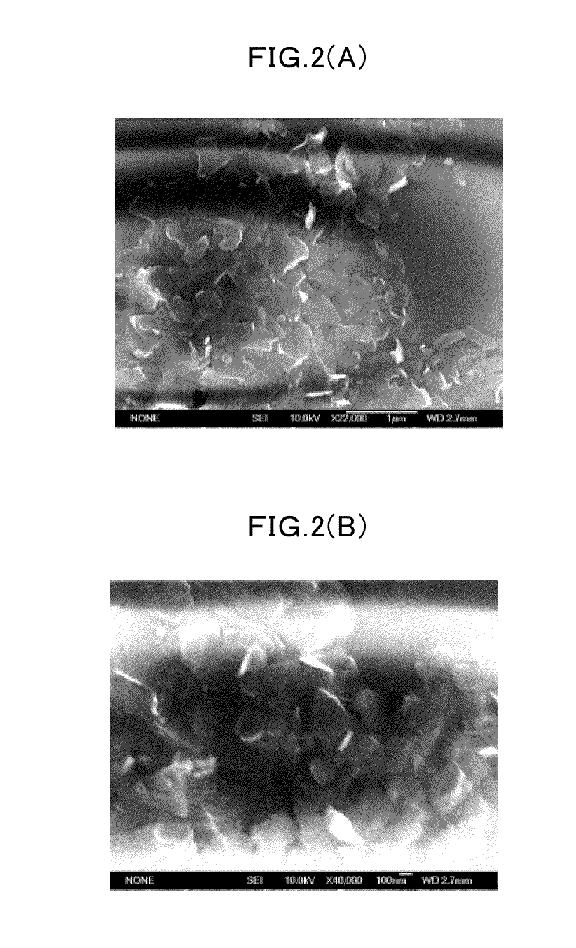

FIGS. 1 (A) and 1 (B) are scanning electron microscopic images of pristine boron nitride powder used as a raw material. FIGS. 2 (A) and 2 (B) are scanning electron microscopic images of the boron nitride nanosheet obtained by the method describe above.

As shown in FIGS. 1 (A) and 1 (B), the thickness of the raw material was in the order of micrometers, whereas as shown in FIGS. 2 (A) and 2 (B), the thickness of the boron nitride nanosheet obtained was thinner. Although accurate thickness cannot be deduced from these scanning electron microscopic images, by forming the raw material into a nanosheet, its thickness was made thinner and flexibility increased, allowing the thin film to be bent, and thus transmission electron microscopic images of the edge of the boron nitride nanosheet were obtained.

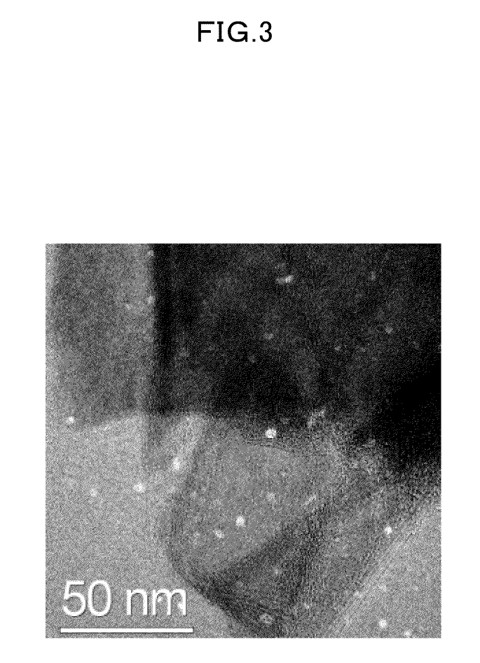

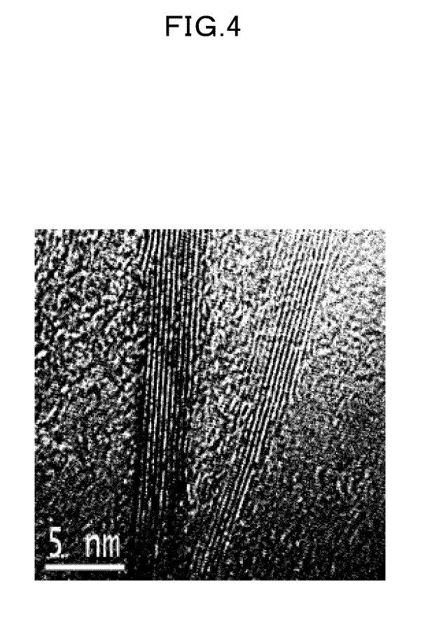

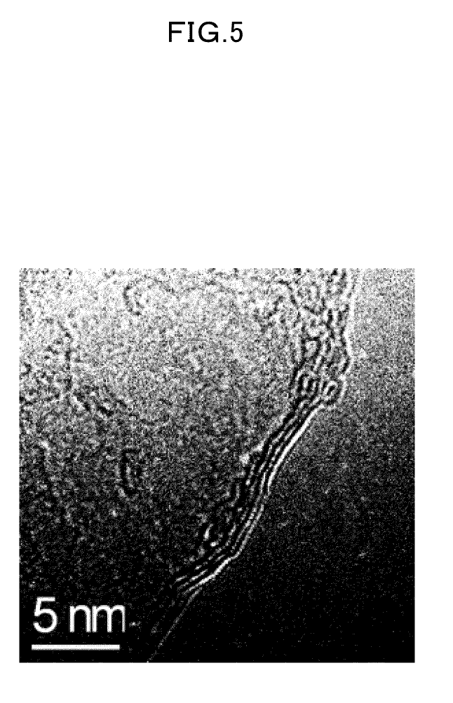

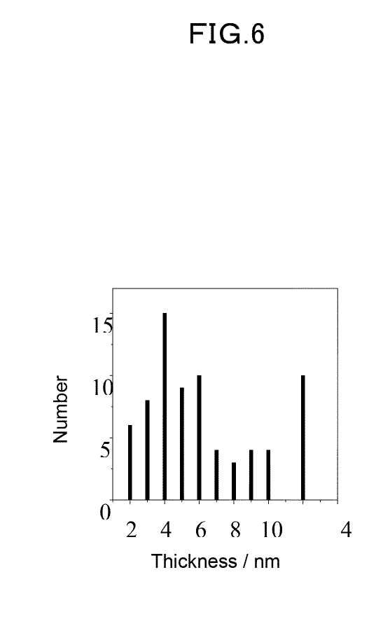

FIG. 3 to FIG. 5 are transmission electron microscopic images of the boron nitride nanosheet of the present invention. As shown in FIG. 3, the boron nitride nanosheet is extremely thin with enhanced transparency. The striped portion on the left side of FIG. 4 has the thickness of 4 nm, whereas that on the right side has the thickness of 3 nm. The thickness of the cross section in FIG. 5 is 1.2 nm, and the interplanar distance of (002) plane is approximately 0.35 nm, which implies that the sheet has three layers. In addition, the thickness of the sheet shown in transmission electron microscopic images was checked at 73 positions. The chart in FIG. 6 shows the statistics of boron nitride nanosheets' distribution. The thickness was found to be 10 nm or less at 65 positions, and 7 nm or less at 52 positions. Namely, it was found that the positions at which the thickness was 10 nm or less accounted for 85% of the entire positions measured.

### Example 2

9 mg of the boron nitride nanosheet (BNNSs) of the present invention was dispersed in 10 mL of chloroform, to which 3 g of polymethyl methacrylate (PMMA) was added to produce a polymeric composite solution (BNNSs:PMMA=0.3:100 parts by weight). This solution was placed in a vacuum drier at 60° C. for overnight to evaporate the solvent, thus forming a polymeric composite film. As a comparative example, a polymethyl methacrylate film not containing the boron nitride nanosheet of the present invention was also formed under the same conditions.

Difference in transparency was not found by naked eye observation between the polymeric composite film containing the boron nitride nanosheet of the present invention and a polymer, and an only polymethyl methacrylate film (hereinafter referred to as “blank polymethyl methacrylate film” [or blank PMMA]).

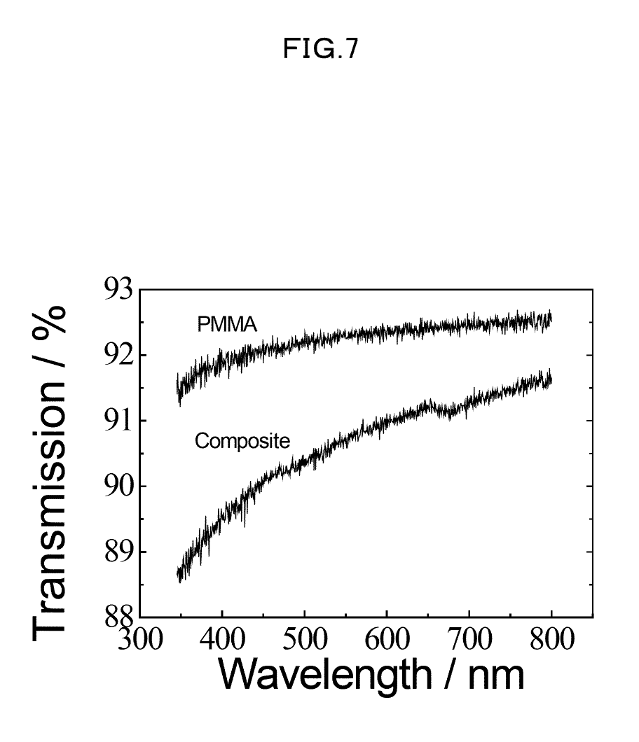

FIG. 7 shows the result of light transmittance of the polymeric composite film and the blank polymethyl methacrylate film. The upper curve means the light transmittance of the blank polymethyl methacrylate film, whereas the lower curve means the polymeric composite film. It was found that the blank polymethyl methacrylate film exhibited transmittance of approximately 92% or higher over the entire measured wavelength range. Meanwhile, the polymeric composite film exhibited transmittance of 91% or higher at the wavelength of 600 nm or longer, but exhibited significantly lower transmittance than the blank polymethyl methacrylate film at the wavelength shorter than 600 nm. The polymeric composite film exhibited light transmittance of 90% or higher over the entire visible range.

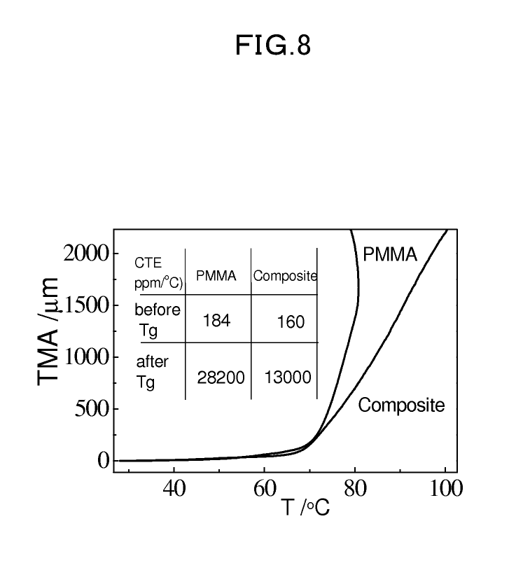

The coefficient of thermal expansion of the polymeric composite film and blank polymethyl methacrylate was measured using a thermomechanical analyzer. FIG. 8 shows the result. As a result of adding the boron nitride nanosheets of the present invention to form a composite, the coefficient of thermal expansion of the composite was found to be smaller than the blank polymethyl methacrylate at any temperature regardless of whether it was at the glass transition temperature or higher, or lower, which implies that the composite has higher dimensional resistance. At the glass transition temperature or higher, in particular, the coefficient of thermal expansion reduced from 28200 ppm/° C. to 13000 ppm/° C. although only 0.3 wt % of the boron nitride nanosheets were added. It was also found as a result of analysis conducted using a differential scanning calorimeter that the glass transition temperature shifted slightly from 69.7° C. to 72.0° C.

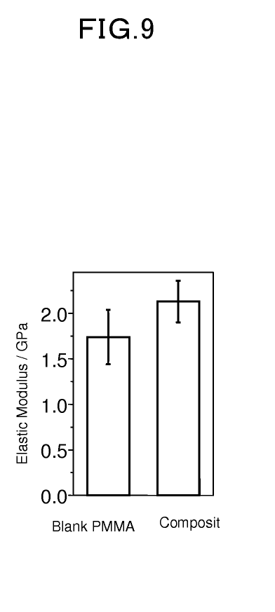

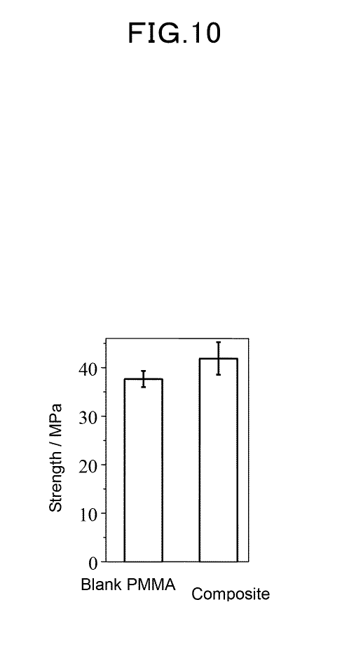

FIG. 9 and FIG. 10 show the measurement result of the elastic modulus and the tensile strength of the polymeric composite film and the blank polymethyl methacrylate film. FIG. 9 shows that the elastic modulus of the polymeric composite has increased by 22%, from 1.74 GPa to 2.13 GPa. Note that eight samples were used to measure the elastic modulus and the tensile strength.

As shown in FIG. 10, the tensile strength of the polymeric composite was higher by 11%.

Addition of the boron nitride nanosheet of the amount as small as 0.13 wt % has thus improved the physical properties significantly, which implies how thin the boron nitride nanosheet of the present invention is and how significant the effect of its addition is. The effect of addition of a very small amount of the BNNSs to polymer is unexpected and surprising since it is known that addition of 1 wt % carbon nanotubes to PMMA is necessary to increase the tensile strength by the 15% and the tensile toughness by 17.5% as reported by Lee et al (W. J. Lee, S. E. Lee, C. G. Kim, Compos. Struct. 2006, 76, 406; L. Q. Liu, H. D. Wangner, Compos. Interface. 2007, 14, 285).

### INDUSTRIAL APPLICABILITY

The present invention provides a thinner boron nitride nanosheet along with a facilitated production method of the boron nitride nanosheet. The boron nitride nanosheet of the present invention is not only useful as a polymeric composite filler to improve polymer properties but also applicable as screen materials used in the photoelectron field. The polymeric composite containing the boron nitride nanosheet of the present invention as filler can be used as microelectronics parts having excellent insulating properties and/or thermal conductivity or as optical device materials for photoluminescence and electroluminescence.

What is claimed is:

1. Boron nitride nanosheet, comprising: a three-layered hexagonal boron nitride, wherein the laminar structure is in a form of multi-layered hexagonal boron nitride with some of its layers peeled.

2. The boron nitride nanosheet according to claim 1, wherein the thickness of the three-layered hexagonal boron nitride nanosheet is from 1 nm to 10 nm.

3. A method for producing the boron nitride nanosheet according to claim 1 or 2, comprising:
dispersing pristine hexagonal boron nitride powder in an organic solvent and;
subjecting ultrasonication to the fluid dispersion of the pristine hexagonal boron nitride powder.

4. The method for producing the boron nitride nanosheet according to claim 3, wherein the duration of the ultrasonication is from 5 hours to 24 hours.

5. The method for producing the boron nitride nanosheet according to claim 3, further subjecting centrifugal separation and drying after the ultrasonication.

6. A polymeric composite, comprising at least one type of polymer and the boron nitride nanosheets according to claim 1 or 2, wherein the boron nitride nanosheets is present in an amount of 0.01 to 50 parts by weight per 100 parts by weight of the polymer.

7. The polymeric composite according to claim 6, wherein the polymer is an acrylic polymer.

8. The polymeric composite according to claim 7, wherein the acrylic polymer is polymethyl methacrylate.

9. A method for producing the polymeric composite according to any one of claims 6 to 8, comprising steps of:
(i) mixing the boron nitride nanotsheets with a solvent to obtain dispersion,
(ii) adding the polymer to the dispersion to obtain a polymeric composite solution such that the amount of the boron nitride nanosheets is 0.01 to 50 parts by weight per 100 parts by weight of the polymer, and
(iii) removing the solvent from the polymeric composite solution.

10. Optical material containing the polymeric composite according to any one of claims 6 to 8.

11. Formed article of the polymeric composite according to any one of claims 6 to 8.
